(19) United States
(12) Patent Application Publication
(10) Pub. No.: US 2013/0180918 A1
(43) Pub. Date: Jul. 18, 2013

(54) Water Filtration Device for the Production of Medical Grade Water for Injection

(71) Applicants: Philip J. Scarpa, Cocoa Beach, FL (US); Wolfgang Scheuer, Victoria (CA)

(72) Inventors: Philip J. Scarpa, Cocoa Beach, FL (US); Wolfgang Scheuer, Victoria (CA)

(21) Appl. No.: 13/739,344

(22) Filed: Jan. 11, 2013

Related U.S. Application Data
(60) Provisional application No. 61/586,081, filed on Jan. 12, 2012.

(51) Int. Cl. C02F 9/00

(52) U.S. Cl. CPC C02F 9/00
USPC 210/638; 210/259; 210/258; 210/257.2

(57) ABSTRACT

A water filtration device for the production of medical grade water for injection from a potable water source is provided including only the following two filter components: 1) a mixed ion bed resin filter and 2) a semi-permeable reverse osmosis membrane filter. This device provides a low cost, onsite method of purifying potable water into medical grade water for injection satisfying United States Pharmacopeia Water For Injection (USP WFI) standards.

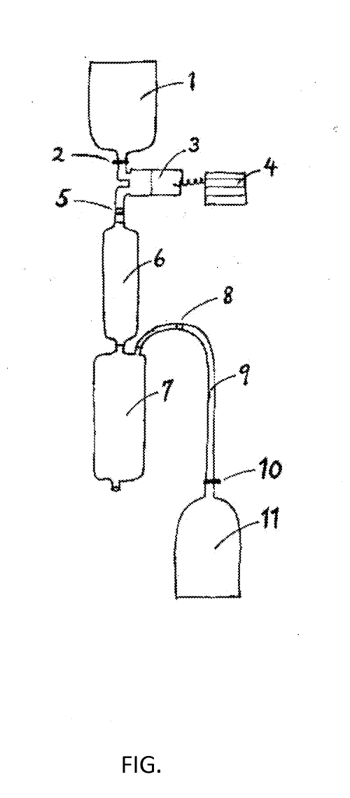

### CROSS-REFERENCE TO RELATED APPLICATIONS

This application claims the benefit, under 35 U.S.C. 119(e), of U.S. Provisional patent application No. 61/586,081 filed Jan. 12, 2012, the contents of which are incorporated herein by reference.

### STATEMENT REGARDING FEDERALLY SPONSORED RESEARCH OR DEVELOPMENT

This invention was made with Government support under contract NNK10OW43P awarded by NASA. The Government has certain rights to this invention.

### BACKGROUND OF THE INVENTION

1. Field of the Invention

The present invention relates to a water filtration device including only the following two filter components: 1) a mixed ion bed resin filter and 2) a semi-permeable reverse osmosis membrane filter. The present invention further relates to a water purification method using such a water filtration device to produce medical grade water for injection satisfying United States Pharmacopeia Water For Injection (USP WFI) standards.

2. Description of Related Art

There are several medical conditions that require medical grade water for injection. Water for injection is needed for creation of isotonic fluids for intravenous (IV) injection, intramuscular or subcutaneous injections, for mixing with medications for injection, for mixing with blood products for injection, for wound hydration or wound irrigation. Patients with burns, bleeding or trauma can require tens of liters of injected fluid within the first days of the injury. Even less serious medical conditions involving vomiting and diarrhea can quickly decompensate without quick and aggressive fluid replacement treatment. Medical fluids have storage requirements, finite time of use (shelf life) and mass and volume demands. To ensure availability, there must also be a reliable quality water source, and a production and distribution infrastructure. These factors are usually not a concern in resource-rich and developed metropolitan areas. However, medical activities in space exploration and on the ground in military or humanitarian relief efforts often occur in remote or austere environments where limitations of mass, volume, storage, shelf-life, transportation, and local resources severely restrict the availability of such important fluids. Therefore, for medical activities occurring in these types of remote or austere environments, there is a clear need for a portable, on-site, on demand production of medical grade water for injection.

Since medical grade water for injection fluids can bypass the usual bodily defenses provided by the skin and digestive system, the requirements for water for injection are strict and demanding. Fluids for injection must be relatively free of inorganic and organic impurities. Sterile water for medical use is commonly produced by large factory-based methods using multistep filtration and distillation, and these processes are complicated and expensive to meet these requirements. In the United States, medical grade water for injection must meet the standards of the United States Pharmacopeia (USP) standards for Water For Injection (WFI) which are Total Bacteria less than 10 cfu/100 ml, Conductivity less than 1.3 uS/cm, Endotoxins less than 0.25 EU/ml, and Total Organic Carbon (TOC) less than 0.50 mg/L.

There are previously used methods that do not use distillation as part of their water for injection production. Some do not provide evidence that they satisfy current USP WFI standards. Some prior methods are commercially available portable devices which claim to clean water for medical uses but do not clean water sufficiently to injection standards and one such manufacturer appropriately disclaims this fact on their devices (PrisMedical Corporation, Napa, Calif.). Nonetheless, these products are used by the U.S. military for such purposes with some risk, due to the high need and lack of any alternative portable water purification technologies. Thus such a portable device to produce USP WFI would have commercial viability.

Previous methods and systems limit portability since they are large in size and weight, have chemical or large power requirements, or do not have high production rates or high total volume outputs. Some have a complex series of filter components in order to include, all in one device, the capability to process any quality of source water acquired from the field. In fact, most prior methods and devices for portable water for injection production contain greater than two filter components and often include carbon and particulate filters. This approach fails to recognize that these are unnecessary additions as potable water is readily available or is otherwise easily created by one of several readily available drinking water production techniques and so does not have to be a part of the water for injection system. Using other than potable water for water for injection production also significantly shortens the life of downstream filters through exhaustion or fouling by deposit accumulations and microbial growth.

Prior methods have also included only adsorption filtration, which does not utilize a membrane, or use a permeable membrane filter. The expectations of these methods are to allow for high flow rates under gravity-only gradients. However, it does not appear that these known methods produce water which meets acceptable USP Water For Injection standards.

Therefore, there exists a worldwide need for portable, low cost medical grade water production on-site and on-demand in remote or austere environments.

### BRIEF SUMMARY OF THE INVENTION

The present invention provides for a water filtration device for the production of medical grade water for injection (USP WFI) from a potable water source. For filtration purposes, the water filtration device only includes the following two filter components: 1) a mixed ion bed resin filter and 2) a semi-permeable reverse osmosis membrane filter. This water filtration device does not include carbon filters, particulate filters, chemical additive treatments, pH adjustment treatments, ultraviolet (UV) treatments, electrodialysis, heating, or any other water purification device(s) and/or chemical additive(s) for purification of the water provided in the device. In one embodiment, the water filtration device is a portable device that is simple and lightweight.

The water purification method for making the medical grade water for injection includes the following steps in order:
1) providing potable water from a potable water source to an inlet of a mixed ion bed resin filter containing mixed ion bed resin;
2) filtering the potable water through the mixed ion bed resin to produce a first filtered water supply;
3) directing the first filtered water supply from an outlet of the mixed ion bed resin filter to an inlet of a semi-permeable reverse osmosis membrane filter containing a semi-permeable reverse osmosis membrane;
4) perfusing the first filtered water supply through the semi-permeable reverse osmosis member to produce a source of medical grade water for injection;
5) removing the medical grade water for injection from an outlet of the semi-permeable reverse osmosis membrane filter; and
   wherein the water purification method does not include any additional water purifying steps.

The water filtration device of the present invention provides for a low-cost and onsite purification of potable water to medical grade water for injection. In one embodiment, the device is simple, small, portable, lightweight, easy-to-use, reliable and provides high output for use by the military, by humanitarian relief efforts, and by other medical operations that occur in remote or austere environments.

The present water filtration device is a simple two-filter component system. The water filtration device does not use a poor quality water source but utilizes only potable water sources, which are usually readily available or easily producible. In a preferred embodiment, the water filtration device achieves simplicity by the novel use of a high quality grade mixed ion bed resin eliminating the need for additional carbon and particulate filters. The invention enables the production of consistent high quality water by utilizing a semi-permeable reverse osmosis membrane filter which allows for nanofiltration. Consistent high quality water is also enhanced by having the semi-permeable reverse osmosis membrane filter downstream of the mixed ion bed resin filter to catch any debris released by the mixed ion bed resin filter. The invention provides a high output rate which is assured by a pumped pressurized flow. Pumped pressurized flow also allows for use of the water filtration device in any gravity orientation. The water filtration device provides high volume output and long operating life by lowering the semi-permeable reverse osmosis membrane filter fouling. The semi-permeable reverse osmosis membrane filter fouling is lowered by the use of a mixed ion bed resin filtering upstream prior to the semi-permeable reverse osmosis membrane filter and by utilizing only potable water sources. These qualities allow for the easy to use, dependable, on-site production of USP WFI water for medical activities in areas with limited resources, storage, or resupply and so are especially useful in space missions, in field operations by the military, in autonomous environments such as on submarines and on surface or cruise ships, in humanitarian relief efforts, and in other medical operations that occur in remote or austere environments.

The purified product water can be used for any purpose requiring medical grade water for injection, such as wound irrigation, medication reconstitution, preparation of intravenous solutions (e.g., isotonic saline, lactated ringers), preparation of dialysate, and reconstituting freeze dried blood products.

### BRIEF DESCRIPTION OF THE DRAWING

The features and advantages of the present invention will become apparent from the following detailed description of a preferred embodiment thereof, taken in conjunction with the accompanying drawing, in which:

FIGURE is a schematic drawing illustrating one embodiment of a water filtration device in accordance with the present invention for producing medical grade water for injection.

### DETAILED DESCRIPTION OF THE INVENTION

A water filtration device for the production of medical grade water for injection from a potable water source is provided including only the following two filter components: 1) a mixed ion bed resin filter and 2) a semi-permeable reverse osmosis membrane filter. The potable water source, mixed ion bed resin filter and semi-permeable reverse osmosis membrane filter are connected in order such that water flows from the potable water source, then through the mixed ion bed resin filter and then through the semi-permeable reverse osmosis membrane filter. This water filtration device does not include carbon/particulate filters, chemical additive treatment, pH adjustment treatment, UV treatment, electrodialysis, heating, or any other devices/additives for purifying the potable water source.

The water filtration device produces medical grade water for injection that meets all USP standards for Water For Injection (USP WFI) which are: 1) Total Bacteria≦10 cfu/100 ml, 2) Conductivity≦1.3 uS/cm, 3) Endotoxins≦0.25 EU/ml, and 4) Total Organic Carbon≦0.50 mg/L. In one embodiment of the present invention, the water filtration device is portable and weighs 1 kilogram or less and measures 25L×13W×7.5H centimeters (in storage configuration). In one embodiment of the present invention, the water filtration device produces at least 1 liter of medical grade water for injection per 21 minutes with a capacity of hundreds of liters.

The water purification method for making the medical grade water for injection includes the following steps in order:
1) providing potable water from a potable water source to an inlet of a mixed ion bed resin filter containing mixed ion bed resin;
2) filtering the potable water through the mixed ion bed resin to produce a first filtered water supply;
3) directing the first filtered water supply from an outlet of the mixed ion bed resin filter to an inlet of a semi-permeable reverse osmosis membrane filter containing a semi-permeable reverse osmosis membrane;
4) perfusing the first filtered water supply through the semi-permeable reverse osmosis member to produce a source of medical grade water for injection;
5) removing the medical grade water for injection from an outlet of the semi-permeable reverse osmosis membrane filter; and
   wherein the water purification method does not include any additional water purifying steps.

The FIGURE illustrates a water filtration device in accordance with one embodiment of the present invention. Potable water is placed in a source water bag 1. In most operations potable water, meeting US Environmental Protection Agency (EPA) primary drinking water standards, is readily available or producible by a number of drinking water preparation methods. To limit the unnecessary size and complexity of the water filtration device, the water filtration device is designed to use only potable water sources. All device components are preferably connected by standard medical grade tubing and couplings. The proximal output end of the source water bag 1 preferably contains one tubing clamp 2 for water flow adjustments. In this embodiment, a miniature electric pump 3 with a battery pack 4 provides a slight pressure, up to 30 psig, to cause a constant and reliable flow of water through the water filtration device regardless of its orientation in gravity, an important characteristic for field operations. Forward flow of water through the device may also be assured by tubing in-line check valves 5 and 10. Potable water flows from the source water bag 1 into an inlet of a mixed ion bed resin filter 6 where it is filtered to a first filtered water supply that exits from an outlet of the mixed ion bed resin filter 6. In this embodiment, the mixed ion bed resin filter 6 includes a resin filter module containing a high quality grade mixed ion bed resin. High quality grade mixed ion bed resins have very low organic, inorganic and ionic impurities (ionic impurities less than 50-100 ppm) and total organic carbon leachables (TOC less than 1 ppb after 100 resin bed rinse volumes). They include hydrogen exchange and a tight polymer structure in its resin gel porosities (greater than 90% have a 16-45 mesh size, US Standard). In this embodiment, for example, the resin filter module may include about 57 grams of high quality grade mixed ion bed resin such as MB-10-Ultra resin, available from ResinTech, Inc., NJ. The high quality grade mixed ion bed resin may include a 60% Anion and 40% Cation mixture. The physical properties of one useful high quality grade mixed ion bed resin are provided in Table 1:

TABLE 1

| | |
|---|---|
| Functional Structure | |
| Cation (Hydrogen form) | RSO₃⁻H⁺ (Gel) |
| Anion (Hydroxyl Form) | R₄N⁺OH⁻ (Type One Gel) |
| Physical Form | Tough, Spherical Beads |
| Screen Size Distribution | |
| +16 mesh (U.S. Std) | <2 percent |
| −45 mesh (U.S. Std) | <2 percent |
| Volume Ratio (as shipped): | |
| Cation | 40 percent |
| Anion | 60 percent |
| Total Capacity | |
| Cation | 1.95 meq/mL min. (H form) |
| Anion | 1.1 meq/mL min. (OH form) |
| Column Operating Capacity | Initial Cycle |
| Electrolyte Breakthrough | 0.60 meq/mL (13 Kgrs/cu. ft.) min. |
| Moisture Content (as shipped): | 60 percent max. |
| Maximum Operating Temperature | |
| Non-regenerable | 80° C.* (175° F.) |
| Regenerable | 60° C. (140° F.) |
| Operating Flow Rate | 2 to 10 gpm/cu.ft. (typical) |
| pH Range | 0-14 |
| Cationic Trace Impurities | |
| Monovalent ions | 50 ppm as Na |
| Magnesium | <100 ppm |
| Iron | <100 ppm |
| Copper | <100 ppm |
| Heavy Metals (as Lead) | <100 ppm |
| Anionic Trace Impurities | |
| Sodium | <100 ppm |
| Silica | <100 ppm |
| Zinc | <100 ppm |
| Borate | <100 ppm |
| Iron | <100 ppm |

In this embodiment, the resin filter module has a removable end so the resin filter module can easily be replaced with new high quality grade mixed ion bed resin. The resin filter module may contain a screen filter of food grade plastic on both ends of the module. The plastic is long lasting and does not require changing as is expected in customary foam filters used with commercial resin modules. These mesh ends were engineered to allow water to flow through the resin filter module at a very fast flow rate without congestion. Water processing occurs through water flow through the mixed ion bed resin filter. Unlike previous water filtration systems containing a carbon filter component (which remove chemicals such as chlorine, trihalomethanes, chloramine, and uncharged organic molecules) and typical deionization resin filters (which remove mineral ions, such as cations as in sodium, calcium, iron, and copper, and anions as in chloride and sulfate), the novel use of a mixed ion bed resin filter containing high quality grade mixed ion bed resin is able to perform the capabilities of both a carbon filter and a typical deionization resin filter by removing particulates, chemicals, mineral ions, some organic molecules, as well as neutralize the water. Therefore the use of high quality grade mixed ion bed resin in the mixed ion bed resin filter eliminates the need for additional carbon and particulate filters found in previous water for injection production methods and devices, allowing for a simple two-filter component system.

After the water is filtered through the mixed ion bed resin filter 6, the first filtered water supply is directed from the outlet of the mixed ion bed resin filter 6 to an inlet of a semi-permeable reverse osmosis (RO) membrane filter 7. Once inside the semi-permeable reverse osmosis membrane filter, the first filtered water supply perfuses through a semi-permeable RO membrane through a reverse osmosis process and exits as medical grade water for injection at an outlet of the semi-permeable RO membrane filter 7. Relatively small semi-permeable RO membrane filters are commercially available from Nimbus Water Systems of Murrieta, Calif. The semi-permeable RO membrane performs nanofiltration, filtering out particles greater than 1 nanometer. Reverse osmosis is accomplished by pressurizing the first filtered water supply across the semi-permeable reverse osmosis membrane at a pressure higher than the osmotic pressure of the solutes being removed from the first filtered water supply. In one embodiment, the pressure in this device is supplied by the miniature electric pump 3. Perfusion through the semi-permeable reverse osmosis membrane is highly reliable and removes pyrogens, such as endotoxins and organic carbons, as well as residual chemicals, and microorganisms including bacteria and viruses, all typically up to 99%.

Tests have been performed to verify the performance of other water purification systems which seek high flow rates with gravity-only provided pressure utilizing methods that either do not use membrane-based filters or that use permeable membrane filters. The tests have confirmed that these previous systems failed to meet water for injection standards. Whereas, the present water filtration device, utilizing a semi-permeable reverse osmosis membrane, consistently produces high quality water through nanofiltration. Consistent high quality water is also enhanced by having the semi-permeable reverse osmosis membrane downstream of the mixed ion bed resin filter in order to catch any debris released by the mixed ion bed resin filter. High output rates of 30-75 ml/min medical grade water for injection from the present system, comparable to membrane-less or permeable membrane systems, are assured by a pumped pressurized flow. In one embodiment of the present invention, pumped pressure at 30 psig creates an output rate of 48 ml/min medical grade water for injection. In one embodiment, pumped pressure up to 30 psig is easily created by a small, lightweight (199 grams), self-priming, long running (200 mins) 12 volt battery powered miniature electric pump such as is available by Hargraves Technology Corporation, NC or by Parker Hannifin Corporation, OH, which does not significantly reduce the portability or usability of the water filtration device. Pumped flow also allows for use of the water filtration device in any orientation which is an advantage over gravity-only systems in potential field use. Placement of a mixed ion bed resin filter upstream of the semi-permeable reverse osmosis membrane filter allows for high system volume output and long operating life by reduced membrane fouling. Use of only potable water as source water also reduces membrane fouling.

Medical grade water for injection exiting the outlet of the semi-permeable reverse osmosis membrane filter may then be used as water for injection. In one embodiment, the medical grade water for injection flows from the outlet of the semi-permeable reverse osmosis membrane filter 7 into a collection bag 11 via tubing 9 including one tubing in-line check valve 8 to assure forward flow and one tubing clamp 10 prior to entering collection bag 11. When the collection bag 11 is full, the tubing clamp 10 would be applied to occlude the tubing proximal to the collection bag 11, and allow for cutting the tubing 9 between the check valve 8 and the tubing clamp 10 in order to disconnect the collection bag 11 from the water filtration device.

In one embodiment, the water filtration device contains one collection bag. However, alternate embodiments may include a manifold of several bags or a sterile needle technique can be employed with replacement collection bags.

In one embodiment of the invention, the potable water is provided to the mixed ion bed resin filter from a potable water bag. However, the potable water bag is not required. The inlet of the mixed ion bed resin filter 6 can be placed directly into any potable water source or drinking faucet water tap.

In one alternate embodiment, the resin filter module can be reduced in weight, and have sealed ends rather than screw-on ends when the resin filter module is made disposable and not refillable. The threaded ends of the resin filter module may allow fittings for either ¼ inch or ⅜ inch tubing to be connected. The resin filter modules may also have a quick-connect mechanism built directly into the ends of the resin filter module to further save space.

In addition to the medical grade water for injection, the water filtration device will produce concentrated waste water through its semi-permeable reverse osmosis membrane filter. The water filtration device could directly dump the waste water into the environment. Alternatively, the water filtration device could return waste water back into the source water bag if desired to avoid waste water discharges, although this may shorten the life of the filters in the water filtration device.

In one embodiment, the water filtration device uses electrical power for the miniature electric pump having disposable or rechargeable batteries. However, a manual hand or foot pump attachment can replace the miniature electric pump if electric power is not available.

In one embodiment, sterilized collection bags containing pre-placed crystalline salts can be utilized to allow the medical grade water for injection to form intravenous medical solutions ready for use or storage. Alternatively, a hypertonic salt solution could be injected into a filled collection bag.

In one embodiment of the present invention, the water filtration device may incorporate a shut-off mechanism, such as a flow meter or pressure sensor, to automatically shut off the device so as to allow for unattended use without overfilling the collection bag. Overfilling can also be avoided by providing an equal amount of water of the collection bag capacity into the source water bag.

In one embodiment of the present invention, the water filtration device may incorporate a conductivity sensor after the semi-permeable reverse osmosis membrane filter for quality sensing. This sensor could be linked to an automatic shut-off of the device pump when water conductivity is unacceptable.

The water filtration device can be disposed of after single use or after maximum estimated output with an allocated margin for safety. Alternatively, the mixed ion bed resin filter and/or semi-permeable reverse osmosis membrane filter can be replaced to extend the life of the water filtration device.

The water filtration device should be structurally strong to withstand processing, such as sterilization with gamma ray radiation, gas, or heat, without degradation of capability or materials (cracking, splintering, etc.).

The water filtration device can be flushed, sealed and radiation-sterilized to allow immediate production of medical grade water for injection after device initiation.

In one embodiment, the tubing and internal pressure of the water filtration device should withstand leaking or rupture at four times its maximum operating pressure, with pressure relief mechanisms in place to avoid rupture.

The water filtration device should be rugged and durable for field use. In one embodiment, it will be designed to withstand impacts, vibrations, atmospheric and water pressures, and temperatures expected in most field environments. The exact water filtration device, including the filter sizes, coupling shapes and tubing lengths mentioned and shown in this description, may be adjusted as needed.

In other embodiments, the two separate filters or filter components of the water filtration device may be contained in one casing.

Although the present invention has been described in detail in terms of certain preferred embodiments, other embodiments are possible to those skilled in the art in view of this disclosure herein without exceeding in the scope or departing from the spirit of the claimed invention. Therefore, the present invention is not intended to be limited by the recitation of preferred embodiments, but is intended to be defined by the following claims.

What is claimed is:

1. A water filtration device for the production of medical grade water for injection from a potable water source comprising,
1) a mixed ion bed resin filter having an inlet and an outlet such that said inlet of the mixed ion bed resin filter is capable of connecting to the potable water source; and
2) a semi-permeable reverse osmosis membrane filter having an inlet and an outlet such that said outlet of said mixed ion bed resin filter is connected to said inlet of said semi-permeable reverse osmosis membrane filter, and
wherein the only filters provided in said water filtration device are the filters provided in 1) and 2) and no additional water purifying devices are included.

2. The water filtration device of claim 1, further comprising a pump.

3. The water filtration device of claim 2, wherein said pump is connected prior to the inlet of said mixed ion bed resin filter.

4. The water filtration device of claim 2, wherein said pump generates a pressure of up to 30 psig.

5. The water filtration device of claim 2, wherein said pump is an electric pump that is battery-operated.

6. The water filtration device of claim 1, wherein said potable water source is provided from a source water bag.

7. The water filtration device of claim 1, wherein said mixed ion bed resin filter includes high quality grade mixed ion bed resin.

8. The water filtration device of claim 7, wherein said high quality grade mixed ion bed resin includes 60% Anion and 40% Cation resin.

9. The water filtration device of claim 7, wherein said high quality grade mixed ion bed resin has ionic impurities less than 50-100 ppm and total organic carbon leachables less than 1 ppb after 100 resin bed rinse volumes.

10. A water purification method for making the medical grade water for injection includes the following steps in order:
1) providing potable water from a potable water source to an inlet of a mixed ion bed resin filter containing mixed ion bed resin;
2) filtering the potable water through the mixed ion bed resin to produce a first filtered water supply;
3) directing the first filtered water supply from an outlet of the mixed ion bed resin filter to an inlet of a semi-permeable reverse osmosis membrane filter containing a semi-permeable reverse osmosis membrane;
4) perfusing the first filtered water supply through the semi-permeable reverse osmosis membrane to produce a source of medical grade water for injection;
5) removing the medical grade water for injection from an outlet of the semi-permeable reverse osmosis membrane filter; and
wherein the water purification method does not include any additional water purifying steps.

11. The water purification method of claim 10, wherein said medical grade water for injection meets United States Pharmacopeia Water For Injection (USP WFI) standards which includes Total Bacteria less than 10 cfu/100 ml, Conductivity less than 1.3 uS/cm, Endotoxins less than 0.25 EU/ml, and Total Organic Carbon (TOC) less than 0.50 mg/L.

12. The water purification method of claim 10, wherein said medical grade water is produced at a rate of at least 1 liter of medical grade water for injection per 21 minutes or 48 ml/min.

13. The water purification method of claim 10, further comprising
providing a pump for directing said potable water through said mixed ion bed resin filter and directing said first filtered water supply through said semi-permeable reverse osmosis membrane filter.

14. The water purification method of claim 10, wherein said mixed ion bed resin is a high quality grade mixed ion bed resin having ionic impurities less than 50-100 ppm and total organic carbon leachables less than 1 ppb after 100 resin bed rinse volumes.
